(19) United States
(12) Patent Application Publication
(10) Pub. No.: US 2024/0406622 A1
(43) Pub. Date: Dec. 5, 2024

(54) METHOD AND SYSTEM OF AUTOMATIC MICROPHONE SELECTION FOR MULTI-MICROPHONE ENVIRONMENTS

(71) Applicant: Intel Corporation, Santa Clara, CA (US)

(72) Inventors: Jaison Fernandez, Bangalore (IN); Adam Kupryjanow, Gdansk (PL); Srikanth Potluri, Folsom, CA (US); Tarakesava Reddy Koki, Hyderbad (IN); Aiswarya M. Pious, Bengaluru (IN)

(73) Assignee: Intel Corporation, Santa Clara, CA (US)

(21) Appl. No.: 18/204,856

(22) Filed: Jun. 1, 2023

(51) Int. Cl. H04R 3/00; G10L 21/028; G10L 25/30; G10L 25/60; H04R 5/027; H04R 29/00; H04S 3/00

(52) U.S. Cl. CPC H04R 3/005; G10L 21/028; G10L 25/30; G10L 25/60; H04R 5/027; H04R 29/005; H04S 3/008; H04R 2430/01; H04S 2400/01; H04S 2400/15

(57) ABSTRACT

A computer-implemented method of audio processing comprises receiving, by at least one processor, multiple audio signals from multiple microphones. The audio signals are associated with audio emitted from a same source. The method also may include determining an audio quality indicator of individual ones of the audio signals using a neural network, and selecting at least one of the audio signals depending on the audio quality indicators.

### BACKGROUND

Many people use multiple audio computing devices or peripherals to increase productivity, such as simultaneously using a computer, a mobile phone, and a tablet, where each device has its own microphone (or mic) and may be coupled to the same computer network. During a phone or video conference, all of the microphones on these devices can be in a listening mode at the same time while a user source talks. The microphones will provide audio signals with varying levels of audio quality. This in turn varies the quality of audio emitted from speakers on remote output devices receiving the audio for the phone or video conference and depending on which of the microphones is used to provide the audio to the output devices.

### DESCRIPTION OF THE FIGURES

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of an acoustic environment with multiple microphones and a user source according to at least one of the implementations disclosed herein;

FIG. 2 is a schematic diagram of another acoustic environment with multiple microphones and multiple users according to at least one of the implementations disclosed herein;

FIG. 3 is a flow chart of an example method of automatic microphone selection for multi-microphone environments according to at least one of the implementations described herein;

FIG. 4 is a schematic diagram of an audio processing system with microphone selection according to at least one of the implementations described herein;

FIG. 5 is a schematic diagram of an audio quality assessment unit of the system of FIG. 4 according to at least one of the implementations described herein;

FIGS. 6A-6B is an example detailed method of automatic microphone selection for multi-microphone environments according to at least one of the implementations described herein;

FIG. 7 is a schematic diagram of an audio environment used for testing alternative audio setups;

FIG. 8 is an illustrative diagram of an example system;

FIG. 9 is an illustrative diagram of another example system; and

FIG. 10 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is performed for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes unless the context mentions specific structure. For instance, various architectures employing, for example, multiple integrated circuit (IC) chips and/or packages, and/or various computing devices and/or consumer electronic (CE) devices such as laptop or desktop or other personal (PC) computers, tablets, mobile devices such as smart phones, smart speakers, or smart microphones, conference table microphone(s), video game panels or consoles, high definition audio systems, surround sound or neural surround home theatres, television set top boxes, on-board vehicle systems, dictation machines, security and environment control systems for buildings, and so forth, may implement the techniques and/or arrangements described herein. Further, while the following description may set forth numerous specific details such as logic implementations, types and interrelationships of system components, logic partitioning/integration choices, and so forth, claimed subject matter may be practiced without such specific details. In other instances, some material such as, for example, control structures and full software instruction sequences, may not be shown in detail in order not to obscure the material disclosed herein. The material disclosed herein may be implemented in hardware, firmware, software, or any combination thereof.

The material disclosed herein also may be implemented as instructions stored on a machine-readable medium or memory, which may be read and executed by one or more processors. A machine-readable medium may include any medium and/or mechanism for storing or transmitting information in a form readable by a machine (for example, a computing device). For example, a machine-readable medium may include read-only memory (ROM); random access memory (RAM); magnetic disk storage media; optical storage media; flash memory devices; electrical, optical, acoustical or other forms of propagated signals (e.g., carrier waves, infrared signals, digital signals, and so forth), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, and so forth, indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

As used in the description and the claims, the singular forms “a”, “an” and “the” are intended to include the plural forms as well, unless the context clearly indicates otherwise. It also will be understood that the term “and/or” as used herein refers to and encompasses any and all possible combinations of one or more of the associated listed items.

Systems, articles, and methods of automatic microphone selection for multi-microphone environments.

When multiple microphones are providing audio signals of the same audio source, the audio signals can be assessed to determine which of the audio signals has the best audio quality. The audio signal with the best audio quality can then be transmitted and used to emit the audio from one or more speakers at the highest available quality providing very good intelligibility and so forth.

Conventional microphone networks with simultaneous microphone capture are used for beam forming and for microphone selection for the audio with the least amount of noise (e.g., best noise cancellation or the highest signal-to-noise (SNR) ratio). SNR analysis alone, however, has been found to be inadequate for this task since noise analysis does not factor subjective audio quality (simply referred to herein as audio quality). The audio quality of an audio signal is affected by the physical microphone components and its fabrication, hardware codec gain, the software operations involved, and so forth. For example, distortion of audio related to non-linearities in the audio system, amplifier overloading, and/or clipping, for example, cannot be measurably represented by SNR but such differences can be detected inherently and subjectively by a person listening to the audio. Also, frequency response variations in the audio signals can affect perception of the audio and cannot be detected by SNR alone. Further, time-domain characteristics of an audio signal such as a transient response, or attack and release times of dynamic processors, can affect how a listener perceives the audio. Otherwise, spatial differences such as a soundstage width or imaging that indicates the size of the room the audio source is in, or whether the source is indoors or outdoors, cannot be detected by SNR. All of these can be perceived by a listener at some level or another (whether or not the listener consciously understands these audio characteristics) and cannot all be factored by using SNR analysis alone.

Also, switching from one microphone to another microphone to obtain the best audio signal for transmission and emission, or subsequent audio processing at end applications or consumer devices, can be a disruptive process that can be detected by a user listening to speakers emitting the audio from the microphones. For example, the automatic switching can cause a delay, pause, or jump in audio being output from an audio output system. Also, when one of the users can detect bad quality on one of the listening devices, manual switching delays and interruptions can occur while manually muting and unmuting different devices and peripherals to switch between the microphone audio listening devices. This can result in a bad experience for the user at an output device as well.

To resolve these issues, the method and system described herein determines subjective audio quality of multiple audio signals from multiple microphones to automatically switch to a selected audio signal, and in turn microphone (or just mic), with the best, or better, subjective audio quality during a video or audio conference. The microphones may be on, or may be, listening devices that are coupled to a computer network to be on the audio or video conference to provide the audio signals. The selected audio signal may be used to emit the audio signal at output devices to hear the original audio from a source or may be used for further audio processing. By one form, the selected audio signal is transmitted to remote output devices on a video or audio conference. It will be appreciated that the term “audio signal” herein may include to both (1) signal characteristics and data, such as frequency and amplitudes in any form and of the audio signal, from a listening device and that are received by a system or device (such as a host device) to perform the microphone switch processing on that audio signal, as well as (2) an ongoing audio signal channel from the listening device, and by one form from a particular microphone on the listening device, and to the system or host or other device performing the microphone switch processing.

By one form, the term “audio quality” herein refers to subjective audio quality with at least one or more of those audio characteristics that can be naturally perceived by a person whether or not the person consciously understands the audio characteristic, such as by a person listening to the audio, and is more than just objective characteristics such as a signal-to-noise ratio measure. As mentioned above, this may include subjective audio characteristics or parameters relating to distortion, frequency response, time-domain variations, spatial differences, signal level, reverberation time, user to microphone distance, microphone parameters such as noise floor and SDNR, audio signal pre-processing quality (e.g. build-in Noise Reductor in headset), to name a few examples.

The selection of a best or better audio quality microphone (or audio signal) can be accomplished by subjectively determining the audio quality of each microphone. The present system and method may periodically sample the audio signals of the microphone audio from the available audio listening devices and perform a subjective audio quality analysis. By one approach, the analysis is performed by inputting samples into a subjectively-trained neural network that outputs audio quality scores for each audio signal being analyzed, and for each sample (or sample time period or sample timestamp). The assessed microphone audio quality from the various available devices and peripherals then may be compared to each other, and/or to one or more audio quality thresholds. When a current microphone already being used does not have the best audio quality, the system may switch to a microphone with better audio quality. When such microphone switching can be performed automatically and seamlessly, this provides a high quality listening experience for a user listening to the audio at an output device on the audio or video conference without annoying interruptions, and so forth.

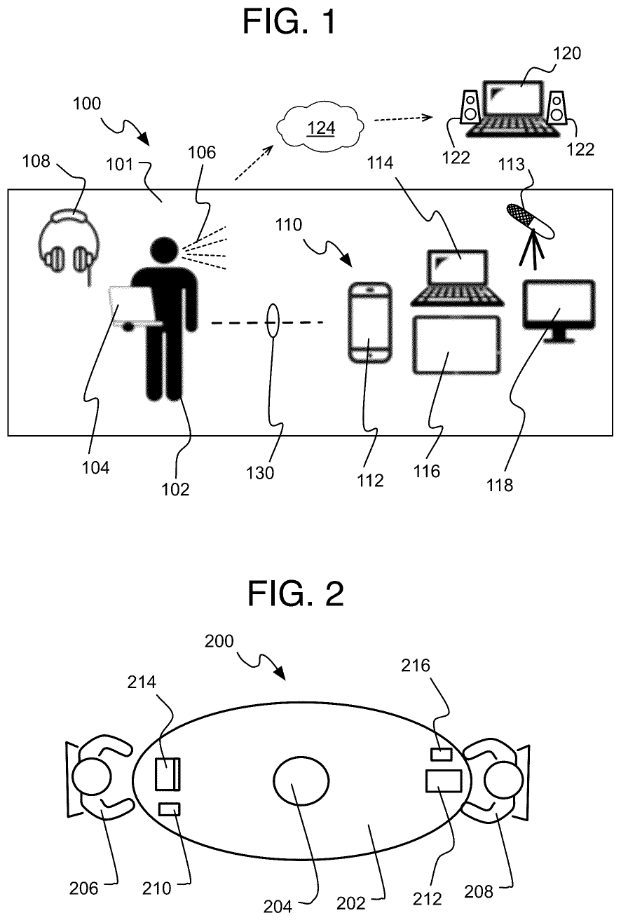

Referring to FIG. 1, an example audio setting (or system) 100 has an example acoustic multi-microphone environment or setting 101 with an audio source or user 102 that may be speaking and emitting acoustic waves 106 into the air within a pickup range of at least two audio or listening devices or peripherals 110. The user 102 may have a laptop or other computer 104 that may be a listening device 110 itself and optionally may be a host device and that has a microphone switching unit to perform the microphone switching described herein. Peripheral devices such as a headset 108 may be coupled to the host device 104 and may have a live microphone. The other listening devices 110 may be coupled directly or indirectly to the host device 104 by a computer or communications network 130 (referred to herein as the conference network). Once the audio signals are analyzed for microphone switching by the host device 104. the host device 104 may provide audio signals to one or more remote output or emission devices 120 via a network 124.

By one example alternative, it also will be appreciated that the microphone switching could work with a single listening device that has multiple microphones. Thus, a single device such as a laptop may initiate a teleconference with remote output devices, have microphone switching circuitry and modules (or units), and may have multiple microphones that can be used to compare subjective audio quality scores. The microphone switching here, however, will be described when multiple separate listening devices are coupled to a teleconference or video conference network.

By one alternative in the example herein, the host device may not be within environment 101. By one example, the host device may be any computing device capable of performing the microphone switch and other desired audio processing tasks. By one form, the host device may be a server communicating with the user's laptop 104 and the other listening devices 110 via conference network 130. Specifically, the host device refers to the device that is hosting and initiating the video or phone conference, and for ease of explanation, it is assumed the host device has a microphone selection unit to perform the microphone switch processing described herein. However, the host device and microphone selection unit could be on different devices.

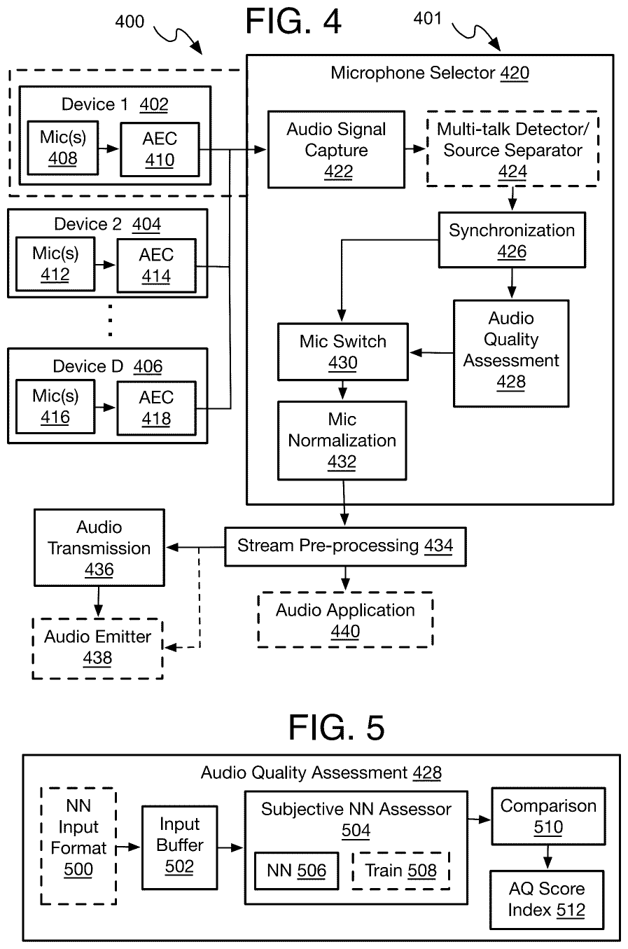

The listening devices 110 may be any device with one or more live microphones such as one or more tablets 116, extension monitors with one or more microphones 118, additional computers or laptops 114 of any kind, any variety of mobile devices such as smartphones 112, one or more free standing or separate microphones 113, and so forth. The type and number of microphones is not limited as long as the microphones can convert acoustic waves into a raw audio signal and can be networked to provide the signals to a microphone selection system or unit (FIG. 4) whether at the host device 104 or another device. The devices 110, and in turn microphones, may be in any position relative to each other within the acoustic environment 101 as long as the microphones of the device can capture the audio emitted by the source or user 102 adequately for analysis by the microphone switching unit at a host device 104 or other device.

Either of the networks 130 or 124, or both, may be a wide area network (WAN), local area network (LAN), or even a personal area network (PAN). The networks 124 and/or 130 may be, or include, the internet, and may be a wired network, wireless network or a combination of both. The two networks 130 and 124 may be considered a single network in one example, or the two networks communicate with each other. By one form, the conference network 130 is a local office network, while network 124 is a WAN that provides external internet access from the office with the acoustic environment 101. By one example form, network 130 is a device-to-device (D2D) direct interconnect network, while network 124 is a WAN.

The output device 120 shown here is a laptop, desktop, tablet, or other computer, server, or other output device with one or more speakers 122 (here shown as external speakers, but could be internal speakers, or any desired speakers). Optionally or additionally, the output device 120 may be any adequate audio emission device including being one or more speakers itself, whether or not smart speakers or any other smart device with one or more speakers, hearing aids, and so forth. One or more, or all, of the output devices 120 should be remote from, or external to, the acoustic environment 101, and may be coupled to network 130, whether or not via network 124, and/or to a host device, which may be host device 104, via wireless or wired connection, or both.

Referring to FIG. 2 for an alternative setup, the microphone switching also can be used in example environments 200 where multiple sources are present. In this example, a conference table 202 has a table microphone console 204 with one or more microphones, a first audio source or user 206 has a mobile phone 210 and a laptop 214, while a second audio source or user 208 has a tablet 212 and a mobile phone 216, each of which may have its own one or more microphones. Any number of users or sources 206 and 208 may be present, and any of the devices mentioned may be input or listening devices 110 as mentioned with system 100 and with at least one microphone. The devices 110 here in environment 200 also are communicatively coupled to networks as mentioned with system 100. The host device and a microphone switch unit may be on any of the listening devices shown or may be on a remote device not shown here.

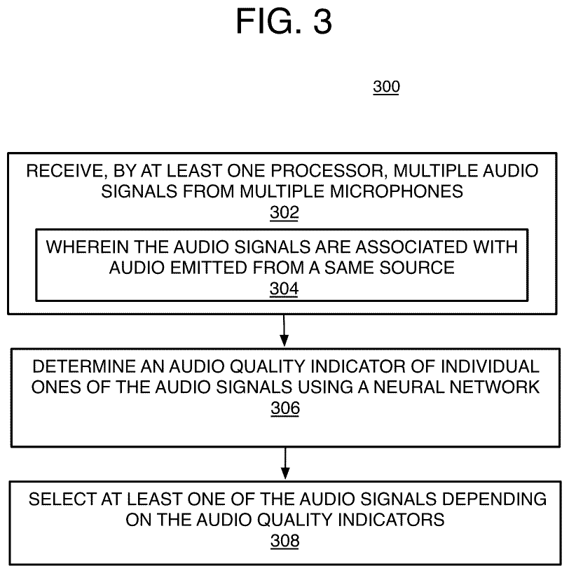

Referring to FIG. 3, an example process 300 for a computer-implemented method of automatic microphone selection for multi-microphone environments is provided. In the illustrated implementation, process 300 may include one or more operations, functions, or actions as illustrated by one or more of operations 302 to 308 numbered evenly. By way of non-limiting example, process 300 may be described herein with reference to example systems or environments 100, 200, 400, 500, 700, 800, 900, and 1000 described herein with FIGS. 1-2, 4-5, and 7-10, or any of the other systems, processes, environments, or networks described herein, and where relevant.

Process 300 may include “receive, by at least one processor, multiple audio signals from multiple microphones” 302. This may include many different types of audio environments with many different types of input or listening devices with at least two microphones, and coupled to one or more, or many different output devices. This also may include the alternative of having a single listening device with two or more microphones as the input. Any listening device may be used as long as the listening devices can be coupled to a host device, system or unit to provide audio signals to the host device, and to perform the microphone switching by a microphone selection unit whether on the host device or another device. Finally, it should be noted that the process 300 is operated during a run-time and live (or real time) video or phone conference, and is not just for training.

This operation also may include capturing samples at a sample capture rate that can be much slower than an assessment rate used to generate subjective audio quality scores. The details are provided below with FIG. 4.

Process 300 may include “wherein the audio signals are associated with audio emitted from a same source” 304. This may include multiple sources as long the multiple audio signals are generated from the same emitted audio from the source(s), and by one form, when the sources are talking one at a time. When multiple sources are speaking at the same time (at the same time point measured in milliseconds for example), either a source separator may be used, or the system is deactivated. When source separation is used, the microphone switching may be based on one of the sources or a microphone score may be based on an average of the audio signals from the single microphone. Also, the location of the source(s) relative to the listening devices does not need to be tracked to perform the microphone switching.

By one form, the audio signals from different microphones also are synchronized to avoid glitches, such as unintentional word duplication, etc., when switching between microphones of various devices. Such synchronizing should maintain the audio signals within 150 ms of each other.

Process 300 then may include “determine an audio quality indicator of individual ones of the audio signals using a neural network” 306. Here, the audio signal values may be formatted to be compatible to the input layer of a subjectively-trained neural network (subjective NN or just NN), when needed, and then placed in a buffer to be input to the subjective NN. Such NN's use subjective datasets generated by having people listen to audio samples and then rating various characteristics of the audio samples. The subjective NN then may be trained to output an audio quality indicator (which may be an audio quality score) and can be used to compare the audio signals. One such NN is a mean opinion score (MOS) NN, and one particular example of a subjective MOS NN is a deep noise suppression MOS (DNSMOS). A DNSMOS type of training dataset may be used for training except here the samples were single words rather than full sentences for training. More details of such subjective NNs are provided below.

The subjective NN is run for each different audio signal, and in turn microphone, to obtain an audio signal indicator or score for each microphone. As described herein, the subjective NN will inherently factor the location of the source(s) relative to the location of the microphones without intentionally computing the relative locations and/or motion of the sources and listening devices with distinct location algorithms. Thus, in some cases, a high quality listening device may be used even though it is not the closest listening device to a source, and in other cases, the listening device closest to a source may be found to provide the best audio quality of an audio signal, and depending on what is inherently detected by the subjective NN.

Process 300 may include “select at least one of the audio signals depending on the audio quality indicators” 308. Here, the audio quality scores or indicators output from the NN and from different audio signals are compared to each other. At least the highest score indicates the microphone and in turn the audio signal with the best audio quality, and the method may switch from the current microphone to the selected microphone. By one alternative form, best or better number of microphones N may be selected, and the audio signals may be combined (such as averaged) into a single audio signal. By one form, selection of the best audio signal with the highest audio quality indicator is not sufficient by itself to initiate a microphone switch. In one approach, the selected microphone or audio signal is an initially selected audio signal. The difference in audio quality score from the current microphone to an initially selected best microphone must be greater than a predetermined audio quality score difference threshold. Otherwise, if the audio quality difference is below the threshold, the audio signals are considered sufficiently close such that the quality difference may not be noticeable to a person and the microphone switch is not worth the added computational load and risk of delay.

Thereafter, the selected audio signal and the current audio signal may be normalized as described below to provide for a more seamless, undetectable microphone switching. To this end, other switching techniques may be used as well, such as a fade-in/fade-out technique to name one example.

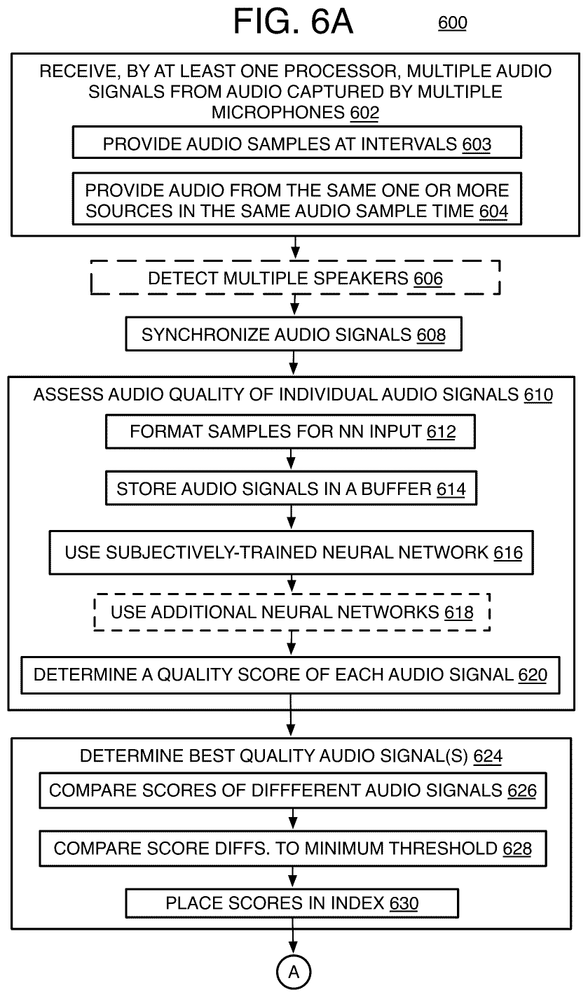

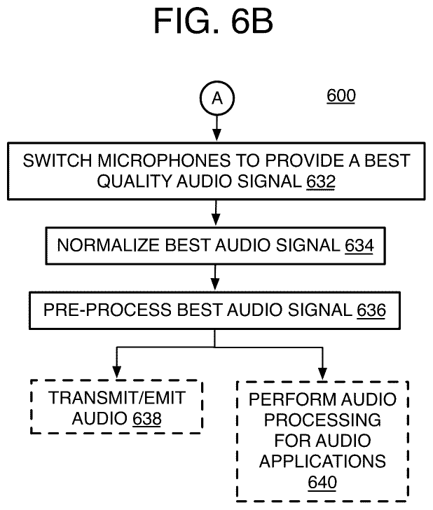

Referring to FIG. 4, an example audio processing system 400 may perform the microphone switching processes disclosed herein and detailed below in FIGS. 6A-6B. The system 400 may have listening devices 1 (402), 2 (404) to D (406), each with one or more mics 408, 412, or 416. By one form, at least two listening devices are being each used, and each listening device has at least one mic. By one form, each listening device 402, 404, 406 may perform at least some internal pre-processing operations before switching microphones. Shown here, each listening device 402, 404, 406 at least has an automatic echo cancellation (AEC) circuitry or unit 410, 414, 418 respectively, and may have other pre-processing (for microphone switching) operations such as analog-to-digital (A/D) converter, denoising, and so forth.

The system 400 also has a microphone selector circuitry or unit 420 here on a host device 401, although the microphone selector unit 420 maybe on a different device. As indicated by the dashed lines, the listening device 1 402 may or may not be part of the host device 401 with the microphone selector unit 420, while the listening devices 1 and 2 (404 to 406) may be remote from the host device 401 and/or microphone selector unit 420. In the present example, the microphone selector unit 420 may be on a host device 401, such as a host laptop 104 (FIG. 1), and the listening device 1 402 may be on the same host device 401, where the device 1 402 is the internal microphones on the host device 401 in this example. Many variations can be used, however, including when all listening devices 402 to 406 are remote from the host device 401, the microphone selector 420, or both, and no listening devices on the host device 401 itself are being used for microphone switching.

The listening devices 1 to D (402 to 406) may be communicatively coupled to the microphone selector 420 via a communications or computer network such as a network 130 (FIG. 1), and may be a LAN, WAN, PAN, or other computer or communications network. By one form, the network is any typical office or residential WiFi network, such as a D2D (WiFi direct) network or any WiFi network.

By one form, the listening devices 402 to 406 may be coupled to the microphone selector 420 and host device in a shared resources mode where hardware resources of the listening devices 402 to 406 can be shared, such as displays, audio components, camera components, etc. The audio signals transmitted from the listening devices 1 to D (402 to 406) are provided to an audio signal capture unit 422. This audio signal capture unit 422 represents any of the communication network reception units as well as initial memory and storage units that may be used to intake the audio signals. This may include receiving or capturing audio samples in capture sample rates and that may be different than assessment sample rates used by the audio quality assessment unit 428 to generate subjective audio quality scores as described herein. It should be noted that the use of the term sample, sampling, or sample rates will refer to the assessment sample, assessment sampling, assessment sample rates, or assessment interval unless the context indicates otherwise.

Specifically, while the audio samples may be captured at a relatively fast capture sampling rate, such as for 10 ms buffers, the subjective audio quality will be assessed at relatively large intervals or assessment samples to reduce computational load on the device. By one form, the assessment intervals may be 2 seconds, and by another alternative, the interval is within a range of 1 to 10 seconds, and the assessment audio samples to be input to the neural network may be a suggested duration of 9 seconds by one example, but actually may be determined during MOS assessment model training. The assessment sample rate may be set to handle many different voice conference formats from 8 kHz to 96 kHz sampling formats, by one example. These audio samples then may be divided into smaller frames with overlapping hop lengths for input to the subjective neural network as described below and when desired. The timing of the intervals of the audio sampling may be set to reduce the computational load (versus having a continuous microphone switching analysis which may consume too much processor time and in turn power), but still set longer than some minimum time interval so that users still have a sufficiently high quality experience. Short intervals are not usually necessary unless the source changes or the source and/or microphones are moving. However, when the timing of the intervals is too long, too many bad audio quality events could occur between the timepoints that samples are obtained thereby permitting noticeable bad audio with artifacts, pauses, jumps, interruptions, and so forth. Specifically, the assessment time interval is a tradeoff among accuracy of MOS estimation (the longer the buffer or interval, the higher the precision), compute complexity (frequent assessment of longer buffers will require a more significant amount of compute), and system sensitivity. For the sensitivity, if a relatively larger time interval is being used, cases of user switching or movement can be missed. Thus, the interval length parameter may be tuned per use case to set the interval within the range of 1 to 10.

The microphone selector unit 420 also has a multi-talk and/or source separator circuitry or unit (or multi-source unit) 424, a synchronization circuitry or unit 426, an audio quality assessment circuitry or unit 428, a mic switch circuitry or unit 430, and a mic normalization circuitry or unit 432. It will be understood that one or more of this circuitry (or these units) may be on multiple different physical devices and may not be all on a same single device, as along as the units are coupled by a network that can communicate microphone switching data as needed. Thus, for example, most of the units may be on a single host device 401 such as a laptop while the hardware for the neural network may be on a remote server. In this case, the host device 401 is a host system to include the neural network as one of its unit. Many different arrangements with remote units can be used.

As to the specific units, and when multi-source unit 424 is a multi-talk detector unit, the microphone selector 420 can be deactivated when it is detected that multiple sources are talking at the same time. Such multi-talk detectors may be based on blind source (or signal) separator (BSS) and/or a concurrent speakers counter network, Countnet, or concurrent speakers detector (CSD) network, for example. In this case, the audio signal sample with the multiple sources is simply dropped, and the unit 420 waits for the next audio signal sample. By another form, at least the audio quality assessment unit 428 is deactivated or disabled (by reducing power for example) so that no assessment and microphone selection takes place. The assessment unit 428 is then repowered with detection of an audio signal with a single source.

Otherwise, the multi-source unit 424 may be a source separator unit that can separate the audio signals for each detected source. Such source separator algorithms such as Conv-tasNet may be used. Whether a BSS or talk-separator technique is being used, all of the separated audio signals may be provided to the synchronization unit 426 and audio quality assessment unit 428 to receive an audio quality score. The scores then may be averaged or otherwise combined to provide a single score to the microphone with the separated sources. By other alternatives, the multi-source unit 424 may select one of the audio signals to continue with microphone switching.

The synchronization unit 426 then may be used to synchronize the input audio signals from the various listening devices to remove temporal distortions or artifacts, as explained in greater detail below. The synchronization unit then streams the synchronized audio signals to both the audio quality assessment unit 428 and the mic switch unit 430

Referring to FIG. 5, the audio quality assessment unit 428 may have a NN input format circuitry or unit 500, an input buffer 502, a subjective NN assessor circuitry or unit 504 with a subjectively-trained neural network 506 and optionally a training circuitry or unit 508, a comparison circuitry or unit 510, and a best audio quality (AQ) score index or index unit 512. The NN input format unit 500 may divide the audio signal samples into frames, and by one form, overlapping frames according to a hop length. Optionally, the NN input format unit 500 also may convert the frames into a format expected by the NN 506. This may include performing domain conversion using short-time Fourier Transform (STFT) as one example, and feature extraction to provide feature vectors of Mel-frequency band (or bin) values as the input to the NN 506. The frames then may be placed into the input buffer 502.

The input buffer 502 may have capacity for 2 seconds of audio data in one example. but can be other sizes as needed. The data dimensions of the buffer 502 may depend on signal length, signal parameters, short-time Fourier Transform (STFT) used to format the audio data for the neural network, and sample rate. For 2 seconds of audio data, STFT that uses 32 ms frame length with 8 ms stride and operates on signals sampled using 16 kHz sample rate, the input buffer 502 may have a size of 256 by 199, i.e., 256 frequency bins and 199 signal frames. Alternatively, inference can be performed by subjective NN Assessor 504 using streaming inference, and in this case, only one STFT frame may be stored in the input buffer at a time.

One or more frames then may be placed in the input surface or layer for the NN 506. The NN 506 may have a combination of convolutional, ReLU, pooling, and fully connected layers with weights computed by training with a subjective training dataset as mentioned elsewhere herein. A training unit 508 used to train the NN 506 may or may not be a part of the subjective NN assessor unit 504. Hardware used to operate the NN 506 may include accelerator hardware such as a specific function accelerator with a multiply-accumulate circuit (MAC) to receive the NN input and additional processing circuitry for other NN operations. By one form, either the accelerator is shared in a context-switching manner, or one or more accelerators may have parallel hardware to perform quality assessments on different audio signals (and in turn different microphone channels) in parallel. By one form, the NN 506 then provides an audio quality score output for each audio signal being analyzed and compared, and these output scores and the identity of their audio signals (or streams) may be stored in an output buffer (not shown).

The comparison unit 510 then may read the scores (or indicators) and compare the scores of the audio signals of the same sample time to each other to determine which audio signal has the best audio quality and should be used. The score of the best audio signal may be an initially selected audio signal and also may be compared to a minimum score difference threshold to determine whether a switch should be performed at all. Thus, no microphone switch will occur when audio signal quality of multiple audio signals cannot be differentiated by a person listening to the audio. The minimum score difference threshold may be stored in firmware, in main storage, or other memory, and may be considered a part of the comparison unit 510.

The best audio quality score (or scores if multiple best audio signals are being tracked) and the identity of the best or better audio signal for a particular sample time are then listed in the AQ score index 512. By one form, the AQ index 512 may have a pair of score and stream (or stream or audio signal identifier) for each best microphone determined by the comparison unit 510. By one form, the score field may be 8 bits, and the size of the channel or mic ID field will depend on how many mics are being used. So the ID field may be as small as 1 bit if only two mics are used.

Referring again to FIG. 4, the mic switch unit 430 then performs audio signal (or microphone) switching techniques to make the switch smoother or more seamless. This may include techniques such as fade-in/fade-out for example that are applied while the audio signal data being provided to end-applications or for emission of the audio signals is being switched.

The mic normalization unit 432 also may normalize the audio signal amplitude values of the selected audio signal by adding a gain determined by automatic gain control (AGC). This also contributes to smoother switch between the current (or now previous) audio signal to the new best audio signal. In other words, the switch is smoother because abrupt level changes from mic to mic will be minimized. The normalization makes the audio signal characteristics closer to a generic or average signal. By one form, typical normalization may be used on the signal. By other forms, a neural network arrangement may be used (such as by using a cycle generative adversarial network (cycleGAN) as one example, to provide a more normalized or generic audio signal that reduces the differences in microphone characteristics in audio signals from the multiple microphones.

An end-use or end-application (or stream) pre-processing unit 434 then may perform pre-processing needed for transmission and/or emission or broadcast, or for specific end applications. This may include denoising and other techniques mentioned below.

When the pre-processed audio signal is being transmitted, an audio transmission unit 436 may encode and transmit the audio to a remote output device or audio emitter 438, which may be a remote device with an audio system and speakers as described above. Whether or not remote, the audio emitter or output unit 438 may have one or more speakers to emit the audio. Instead, or in addition, an audio application unit 440, which can be local or remote on a different remote device, may receive one or more of the audio signals with the best (or better) audio quality to perform audio processing applications such as ASR, SR. AoA detection, specialized audio signal enhancement, and so forth. Many variations are contemplated.

Referring to FIG. 6, an example process 600 for a computer-implemented method of microphone selection using subjective-based audio quality assessments for multi-microphone environments is provided. In the illustrated implementation, process 600 may include one or more operations, functions, or actions as illustrated by one or more of operations 602 to 640 generally numbered evenly. By way of non-limiting example, process 600 may be described herein with reference to example setups 100, 200, and 700, and systems or devices 400, 500, 800, 900, and 1000 described herein with FIGS. 1-2, 4-5, 7-10, or any of the other systems, processes, or networks described herein, and where relevant.

As a preliminary matter, the listening devices with microphones that are to provide audio signals in a video or phone conference with microphone switching capability are expected to be in the same acoustic environment and within a capture or pickup range of the same one or more sources. These devices are coupled or paired on a network as described with network 130 and with a host device that is hosting the conference. Either the host device or another device coupled to the conference network or host device may perform the microphone switching tasks.

During the audio or video (or audio/video (AV)) conference, the microphones convert the captured audio, or audio waves, into audio signals which may include amplitudes in the whole frequency spectrum, or at specific frequencies or frequency bands, that correspond to audio intensity for example. Thus, each microphone senses acoustic waves that are converted into a raw audio signal to be transmitted on a separate audio signal channel to the host device or other device to perform the microphone switching.

By one form, each mic or listening device may perform internal pre-processing such as acoustic echo cancellation (AEC), denoising, analog-to-digital (ADC) conversion, dereverberation, automatic gain control (AGC), beamforming, dynamic range compression, and/or equalization. By one form, the AEC will benefit the microphone switching by providing a cleaner signal. In some cases, however, such initial denoising and other device specific pre-processing could provide unexpected audio signal data to the subjective neural network that results in inaccurate scores. In these cases, the mic will not be selected when no way exists to automatically or manually disable the extra pre-processing.

Process 600 may include “receive, by at least one processor, multiple audio signals from audio captured by multiple microphones” 602. Here, the listening devices or multiple microphones coupled to the network with the host device transmits the audio signals to the host device (or other microphone selection device) over the conference network. By one form, the host (or other) device may initiate the conference call and can start capturing audio streams from all of the other available connected listening devices. As mentioned, while the microphone switching could work with a single listening device that has multiple microphones, the microphone switching is described herein for conferences with multiple separate listening devices.

This operation also includes tracking at least which input listening devices are on the conference network, and managing channels (or audio signals or streams) to add or drop the channels if a listening device, and in turn its microphones, are dropped or newly added to the network and teleconference.

The receiving operation may include “provide audio samples at intervals” 603, or in other words, at a predetermined assessment sampling rate that may be fixed. As mentioned above, this is not the same as the capture sample rate which may be 10 ms. Thus, it is not always necessary to continuously score the audio signals, and therefore the computational load of the microphone switching can be significantly reduced when the assessment is only performed at intervals, such as 2 second assessment intervals or assessment samples, or alternatively between 1 to 10 seconds, as mentioned above, and between the start of consecutive audio samples (or audio clips) extracted from a received audio signal. By one form, each audio assessment sample may have a duration that is 9-10 seconds expected by the neural network 506. It should be noted that the assessment sampling rate could be varied or fixed, and may be determined during the training of the neural network 506. By one form, the assessment sampling rate is set so that the present system may support a sampling rate used in voice over internet protocol (VOIP) communication such as about 8 to 96 KHz.

The receiving operation 602 also may include “provide audio from the same one or more sources in the same audio sample time” 604. In other words, the audio signals from the different microphones should be capturing the same audio emission from the one or more audio sources. While human speech is expected, the sources may be emitting any sounds or noises, whether human or not.

Multiple sources, however, cannot be speaking simultaneously at or within the same milliseconds of timestamps of the audio signal samples for the neural network to provide accurate scores. Thus, process 600 optionally may include “monitor for multiple speakers” 606. This may involve a source separator that can divide the audio signals into multiple audio-signals each being of a different source by techniques or neural networks mentioned above. The microphone switching then can proceed by averaging the scores of the two separated audio signals in the single mic. By another possible alternative, the system may proceed with a selected one of the audio signals (or proceed with each separately), and this may be repeated for a sequence of the audio samples. When the alternative to select one of the audio signals proceeds, the selection of the microphone can be random or can be determined by score, or other criteria.

By an alternative, a multi-talk detector can be used to detect multiple human sources talking simultaneously on a single audio signal, such as by using a blind source (or signal) separator (BSS). If the detector detects multiple sources talking at the same time, the microphone selector unit may deactivate the audio quality assessment and the subjective neural network will not be run to determine audio quality scores for the audio signal with the simultaneous speech, and the next system will operate on the next audio signals in a next interval. By one form, the samples (or audio signals) with simultaneous speakers is just dropped, and the system waits for the next samples or next audio signal. By another option, the power to the synchronization unit and/or assessment unit may be turned off until the detection unit detects an audio signal with a single source. Many variations are contemplated.

Process 600 may include “synchronize audio signals” 608. Since the audio streams are coming from various listening devices with different internal and network delays, time synchronization between audio streams or audio signals from the different microphones should be performed. Audio time synchronization mismatches between the audio signal or stream of the host device compared to audio signal streams from other connected listening devices can generate human detectable audio glitches, such as repeated words, echoes, adding zeros to the signal that distorts the output audio, cutting part of a word, creating discontinuity, and so forth, during the microphone switching from audio signal to another, or can create audio lag in video conferencing and streaming. While perfect synchronization is not required, at least coarse synchronization should be performed to avoid the noticeable glitches and delays. Coarse synchronization here refers to delay of audio signal streams from one listening device to another (or from one microphone to another) being less than 150 ms, 130 ms, or even 100 ms, or less than 100 ms to 150 ms. More precise techniques may have time differences less than 50 ms or 35-40 ms. The shorter the delay, the smoother the switching from one audio signal to another of different microphones. By one approach, a Hammock Harbor technique with time sync standard protocols such as precision time protocol (PTP) may be used to perform the audio stream time synchronization. By other alternatives, the synchronization may be performed simply by tracking the timestamps of the audio signals by using common wall clock time, and the audio signals samples are adjusted to the common clock.

Process 600 may include “assess audio quality of individual audio signals” 610. After the time synchronization, the quality of the audio signals are analyzed by an audio quality assessment unit. Each audio signal (or stream) is analyzed separately by using the subjective NN to provide an audio quality score for each audio signal (or stream) at each audio sample (or sample time or interval).

The audio quality assessment 610 may first include “format samples for NN input” 612. The formatting at least divides the audio samples into frames that can be collected into a 2D input surface or vector for the subjective NN. By one example as mentioned, the frame size may be 20 ms with a hop length of 10 ms, although many other arrangements can be used.

By one approach, the audio signals also may be converted into frequency domain by fast Fourier transform (FFT). Feature extraction then may be applied as part of the formatting. The feature extraction may include obtaining the frequency-domain audio signals and computing a version of the audio signals that can be used by the subjective NN to generate audio quality scores. By one example, this may involve generating feature vectors of Mel-spectrum related values, such as Mel-frequency cepstrum coefficients (MFCCs) or latent domain using learnable encoder-decoder. By one example then, every frame may have a feature vector of Mel-frequency band values, such as 120 bands in this example. These feature vectors are then input into input layer of the subjective NN as described below.

Alternatively, the neural network may receive the frames with audio signal values directly as input without additional formatting to another domain, such as a frequency domain. In this case, the neural network inherently performs its own conversions to a feature domain that can be used to determine the audio quality scores.

Process 600 may include “store audio signals in a buffer” 614, and such as input buffer 502 as described above. The frames will be buffered for a predetermined time such as 1 to 10 seconds so that at least one spoken word will be saved. Otherwise, the buffer time is set depending on the NN techniques being used.

Process 600 may include “use subjectively-trained neural network” 616, which has been found to correspond better with actual human listening experiences or perceptions of audio quality. As mentioned, a subjectively trained NN are those trained with datasets generated by using subjective reactions from a person. Specifically, during the generation of a training dataset for the subjective neural networks, participants are asked to listen to audio samples and provide ratings. By one form, the samples were of single words rather than full sentences. By some examples, this may include questions asking the participants to rate the clarity, loudness, naturalness, distortion, background noise, and overall quality of an audio sample, to name a few examples. Using these responses to generate ground truth audio quality scores for training inherently factors audio signal characteristics mentioned above such as reaction to amounts of distortion, frequency response variations, source location relative to microphone location, and/or the size or the acoustic environment or room. Thus, as mentioned, the system does not need to track the location or proximity of the source relative to the listening devices or the location or proximity of the listening devices relative to each other in order to perform the microphone switching. The subjective analysis herein does this inherently instead. This may be referred to herein as inherent proximity tracking or the system being express-proximity-tracking independent such that distinct proximity computations are not performed. Thus, the microphone switching also works satisfactorily when the user 102 is moving within the acoustic environment 101 as well.

The ratings from the individual questions to generate a training dataset then may be used in a weight averaging or other rating-combining algorithm to generate a single score for the audio sample. Many different techniques may be used, and this may include those based at least partially on International Telecommunications Union (ITU) standards such as ITU-T P.563, P.800, P.808, and so forth. By one example form, the subjective training dataset used for DNSMOS was used here. By another example, a similar dataset was used except for single words rather than full sentences as in the DNSMOS dataset because using words enables the system to assess the signal quality for a shorter part of an audio signal sequence for better accuracy.

By one form, the subjective datasets used for training here also provide clean samples rather than noisy samples. It also should be noted that the training may be different depending on the end-use. For example, training the neural network for transmission and emission of the audio at speakers on an output device may be different than the training for when best or better audio quality signals are to be used for ASR or SR for example. In these cases, the network is trained to maximize word error rate (WER) rather than an MOS.

By one form, the neural network here may be any subjective neural network that is trained on a subjective dataset as described herein. By one example form, the subjective NN is a mean opinion score (MOS) network that averages or combines scores over time, such as a sequence of frames as described herein, to generate an audio quality score for an audio signal sample. By another example form, the subjective NN is a DNSMOS network. It also should be noted that instead of DNSMOS, other alternative, at least partially subjectively-trained neural networks that can be used include perceptual evaluation of speech quality (PESQ), and perceptual objective listening quality analysis (POLQA).

Regarding the input to the subjective NN, and as mentioned above, the input may be a version of Log power Mel spectrogram feature vectors of 120 Mel frequency bands. As mentioned, the frame size may be 20 ms with a hop length of 10 ms. The frequency values may be converted into a dB scale for input to the NN. By one example form, the input is 900×120×1 channel, where 900 refers to 900 feature vectors representing 100 samples/second for a 9 second audio sample. Thus, the resulting output audio quality score may be an average (or other combination, or in other words MOS) score for an entire audio sample.

One example neural network architecture that may be used comprises:

| Layer | Size |
|---|---|
| Input | 900 × 120 × 1 |
| Conv.(3 × 3) + ReLU | 900 × 120 × 32 |
| Maxpool(2 × 2) | 450 × 60 × 32 |
| Conv.(3 × 3) + ReLU | 450 × 60 × 32 |
| Maxpool(2 × 2) | 225 × 30 × 32 |
| Conv.(3 × 3) + ReLU | 225 × 30 × 32 |
| Maxpool(2 × 2) | 112 × 15 × 32 |
| Conv.(3 × 3) + ReLU | 112 × 15 × 32 |
| Globalmaxpool | 1 × 64 |
| Fully connected + ReLU | 1 × 64 |
| Fully connected + ReLU | 1 × 64 |
| Fully connected (output) | 1 × 1 |

As shown on the example NN architecture table above, four convolutional layers may be used with 3×3 filters and with accompanying pool layers with 2×2 filters. The NN finishes with three fully connected (or dense) layers. Most of the layers end with rectified linear unit (ReLU) operations (or layer). The training may use a dropout technique, and by one example, set to 0.3. The surface and channel sizes of each layer is provided as well as recited on the architecture table above. The subjective NN also may have recurrent layers, such as long short-term memory (LSTM) or may use gated recurrent units (GRUs). Otherwise, dynamic augmentation may be performed during network training. It will be appreciated, however, that the NN may have many different architecture variations.

Process 600 optionally may include “use additional neural networks” 618. By one possible alternative form, the subjective audio quality neural network could be used in parallel with an SNR quality network, and the scores of the two networks could be combined to determine a final score. Otherwise, a single network could receive both SNR and subjective scores to provide an output of a best microphone (or audio signal).

Process 600 may include “determine a quality score of each audio signal” 620. The output layer may have one node that provides an audio quality score for the particular audio signal being analyzed and for the sample (or time point) being analyzed. The output may be the score value on a typical audio quality range for a DNSMOS network, and in a range of 1.0 to 5.0, or may be converted to a value that is on the range. Otherwise, the network (or model) can be input with multiple audio streams and output a best one, without a need to perform score comparison and stream selection externally to the network.

Process 600 may include “determine best quality audio signal(s)” 624, and this operation may include “compare scores of different audio signals” 626. By one form, the highest score among all audio signals being analyzed, and the associated selected audio signal and microphone are identified and may be used as the audio signal going forward. By other forms, a comparison value may be determined for each available pair of microphones, such as a difference between the scores of all possible pairs of two audio signals. In this case, the largest comparison value above the current audio signal and microphone indicates the best quality audio signal. By another alternative, some best number N of audio signals are determined, and the audio signals may be combined such as averaged to be used as a single audio signal. Many other variations may be used. Thus, the stream switching may occur if the quality of the score of the current stream (or audio signal) drops or a score of one of the other streams (or audio signals) rises. But this may not be the only criterium for a microphone switch.

Specifically, this operation 624 also may include “compare score diffs. to a minimum threshold” 628. Thus, if an initially selected audio signal has a better audio quality than the current audio signal, that difference in scores or comparison value is then compared to a minimum difference threshold, which by one example is 0.1 for a 1.0 to 5.0 DNSMOS scale. If the difference or comparison value is less than the threshold value, then the difference in quality is more likely to be unnoticed by a person listening and the microphone switch is not worth the computational load and risk of delays.

By another alternative, direct score thresholds may be used where audio signals with subjective audio quality scores below a certain score threshold will not be used and are dropped from consideration right away to maintain some minimum subjective audio quality, and by one form, this is applied even if it is the current audio signal or stream.

By yet another alternative, an upper difference threshold could be used, because even if the audio quality is getting higher, in some cases if the difference in scores between the current and now best quality audio signal is too large, this may be too disruptive to the users.

By another alternative to reduce computational load of the microphone switching, the sampling may be performed at the fixed interval and the microphone switching may be further limited by a minimum mic switching time period. For example, if two speakers or sources are in an acoustic environment and talking to each other, such as in a room in an office, and each has their own listening device and microphone, the microphone switching system may find that the best audio signal is the one closest to the speaker. In this case, rather than having the audio signal of the best microphone being switched back and forth between the two listening devices at a very high frequency that consumes a relatively large computational load, the switching can be limited by setting a higher minimum audio signal score difference threshold at the comparison unit 510. This value may be fixed, or may be adjustable during a system tuning procedure (e.g., by experimenting).

Process 600 may include “place scores in index” 630. Here the audio signals with the best audio quality score or scores are placed in the AQ index and for each sample analyzed. The index tracks which audio signals, and in turn which microphones, had the best quality for each interval as the audio signals are streaming.

By yet another alternative for reducing the amount of microphone switching, the method may set the time for microphone switching at a fixed amount at the AQ index 512. After the audio signal with the best audio quality is selected, the time for switching microphones can be delayed by using an index sampling count so that every nth sampling has an audio signal placed in the index to switch the microphones rather than for every interval. Otherwise, all sampling times have a best score and microphone ID placed in the AQ index, and in this case, only the microphone of the nth sampling count is used in the list within the AQ index.

For example, an identity of a microphone or audio signal and audio quality indicator with a best audio quality to be used and of a sample is determined for a particular sampling time. Thereafter, an index sampling count may be used so that either: (a) every nth sample is placed into the index for microphone switching, or (b) every nth sample within the index is used for microphone switching, where n is greater than 1 when the reduction of microphone switching is desired to reduce computational loads and/or avoid delays. This is only two example ways to control the frequency of microphone switches and many variations are possible.

Process 600 may include “switch microphones to provide a best quality audio signal” 632. Once the quality analysis is done, the best stream information may be passed to the mic switch unit to perform a most-seamless as possible switching of the audio streams, and to the best audio quality signal according to the index for a certain time interval, such as a current time interval. As mentioned, audio techniques such as fade-in/fade-out also can be used.

Process 600 also may include “normalize best audio signal” 634. Normalization is performed on the best quality audio signal to be used going forward and that is to replace the current audio signal. Since the audio streams are coming from various devices, the normalization will remove or reduce noticeable tone (or pitch) differences from microphone to microphone. This will add to the success of the attempt at providing a seamless switching experience of the audio streams. By one option, the normalization adjusts the audio signal amplitude value or automatic gain control (AGC). The normalization makes the audio signal characteristics closer to a generic or average signal. By one form, typical normalization may be used on the signal. By other forms, a neural network arrangement may be used, such as by using a cycle generative adversarial network (cycleGAN) as one example, to provide a more normalized or generic audio signal that reduces the differences in microphone characteristics in audio signals from the multiple microphones.

Process 600 may include “pre-process best audio signal” 636, for audio applications. Here, the selected normalized audio signal then may be submitted to further pre-preprocessing as may be expected by audio transmission and/or emission units, and/or other audio processing applications. Thus, the selected audio signal may be denoised, de-reverberated, beamformed, amplified, compressed, and so forth.

Process 600 optionally may include “transmit and emit audio” 638. Thus, the selected audio signal may be encoded and then transmitted to another device, such as a remote listening device, to be emitted. By other forms, the selected audio signal is encoded for further audio processing, as mentioned herein, and rather than, or in addition to, being emitted.

Process 600 optionally may include “perform audio processing for audio applications” 640, and by using the microphone with the best quality audio signal. Thus, whether or not compressed and transmitted, the selected audio signal may be provided for ASR, SR, AoA detection, beam forming, and so forth.

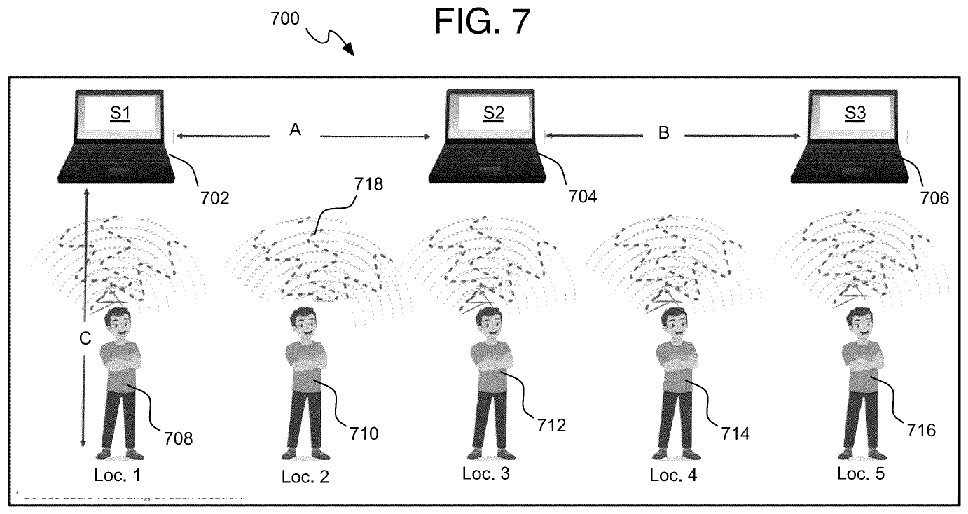

Referring to FIG. 7, tests were performed in an acoustic environmental setting 700. This was not a controlled anechoic chamber, and tests were performed to compare an SNR based audio quality system to the disclosed subjective audio quality scoring system. The tests were performed with a simultaneous recording of a user (or source) speaking within the pickup range of three laptops, here indicated as systems S1, S2, and S3 and starting at positions left (702), middle (704), and right (706) respectively. The speaker was located at five different locations at different emission test sessions and near the system positions 702, 704, and 706. Specifically, the speaker location 1 (708) is left in front of left position 702, location 2 left-middle (LM) 710 is between left (702) and middle (704) positions, location 3 middle (712) is in front of middle position 704, location 4 right-middle (RM) 714 is between middle 704 and right 706 positions, and location 5 right (716) is in front of right position 706, and emitting audio (or acoustic waves) 718.

The systems S1, S2, and S3 were kept apart at a distance from each other of A=B=1.2 m on a table (not shown) with a user (or source) standing at a straight distance of C=1.4 m as shown on FIG. 7. For each location (1-5) of the user, the test was performed three times with at least two of the systems S1, S2, and/or S3 at a different position left 702, middle, 704, or right 706 for each test. The different system positions and user locations for each of the tests are listed on the results Tables 1 and 2 below. In each test, the user reads the same passage for about 20 seconds at the indicated user location. As listed on the tables below, for a configuration 1/recording 1, the system positions and user locations are as shown on FIG. 7. For configuration 2/recording 2, the positions of systems S1 and S2 were switched (between left and middle). For configuration 3/recording 3, system S3 is in the middle, system S1 is on the right, and system S2 is on the left.

The SNR tests were performed by using a static test and a speech period was manually labelled. Then, SNR was calculated as an energy ratio between speech and non-speech periods. The subjective tests were performed by using the DNSMOS neural network as described herein. The tests show the effects of microphone quality and user proximity on audio quality scores.

| | | SNR (Signal to Noise Ratio) | | | | |
|---|---|---|---|---|---|---|
| | | User | User | User | User | User |
| Config #/ | | Loc. 1 | Loc. 2 | Loc. 3 | Loc. 4 | Loc. 5 |
| Recording # | System# | (Left) | (Btw L&M) | (Middle) | (Btw M&R) | (Right) |
| Config 1/ | S1 (Left) | 56.02 | 61.68 | 59.45 | 65.29 | 69.00 |
| Recording 1 | S2 (Middle) | 48.26 | 47.62 | 49.51 | 48.49 | 49.29 |
| | S3 (Right) | 36.57 | 34.93 | 35.41 | 37.19 | 40.93 |
| Config 2/ | S1 (Middle) | 66.49 | 65.85 | 65.01 | 59.28 | 62.30 |
| Recording 2 | S2 (Left) | 51.66 | 52.14 | 53.55 | 47.89 | 44.06 |
| | S3 (Right) | 32.38 | 36.44 | 36.38 | 37.48 | 34.83 |
| Config 3/ | S1 (Right) | 67.81 | 69.08 | 68.91 | 64.39 | 66.62 |
| Recording 3 | S2 (Left) | 50.75 | 49.30 | 50.73 | 46.66 | 47.12 |
| | S3 (Middle) | 35.65 | 38.92 | 41.27 | 41.68 | 39.09 |

below shows SNR ratio results, while Table 2 shows results with audio quality scores when using the DNSMOS neural network.

The SNR Table 1 below shows system 1 has the highest SNR ratios irrespective of system position and user location, which does not always correspond to subjective audio quality.

The DNSMOS analysis, however, shows the variation in MOS scores with respect to changes in the user location and changes in the positions of the systems. While configurations 1 and 2 have different results than with the SNR tests, here too in configuration 3 when system S1 is in the right position 706, system S1 still has the highest score no matter the location of the user. It was concluded that the system S1 in configuration 3 has an extremely good reception angle for one of its microphones that produces such good scores.

Otherwise, in both configurations 1 and 2, the audio quality scores on Table 2 show that the system S1, S2, or S3 closer to the user location 1 to 5 had the best audio quality. Thus, the SNR data is clearly inferior to the subjective testing. The DNSMOS NN analysis was able to distinguish the system with better audio quality with respect to system and user locations. These DNSMOS results also were verified (or correlated) when multiple people listened to the input audio that was used and rated the audio quality separately from the tests performed above.

TABLE 1
SNR

| | | SNR (Signal to Noise Ratio) | | | | |
|---|---|---|---|---|---|---|
| | | User | User | User | User | User |
| Config #/ | | Loc. 1 | Loc. 2 | Loc. 3 | Loc. 4 | Loc. 5 |
| Recording # | System# | (Left) | (Btw L&M) | (Middle) | (Btw M&R) | (Right) |
| Config 1/ | S1 (Left) | 56.02 | 61.68 | 59.45 | 65.29 | 69.00 |
| Recording 1 | S2 (Middle) | 48.26 | 47.62 | 49.51 | 48.49 | 49.29 |
| | S3 (Right) | 36.57 | 34.93 | 35.41 | 37.19 | 40.93 |
| Config 2/ | S1 (Middle) | 66.49 | 65.85 | 65.01 | 59.28 | 62.30 |
| Recording 2 | S2 (Left) | 51.66 | 52.14 | 53.55 | 47.89 | 44.06 |
| | S3 (Right) | 32.38 | 36.44 | 36.38 | 37.48 | 34.83 |
| Config 3/ | S1 (Right) | 67.81 | 69.08 | 68.91 | 64.39 | 66.62 |
| Recording 3 | S2 (Left) | 50.75 | 49.30 | 50.73 | 46.66 | 47.12 |
| | S3 (Middle) | 35.65 | 38.92 | 41.27 | 41.68 | 39.09 |

TABLE 2
SUBJECTIVE

| | | DNSMOS (Deep Noise Suppression Mean Opinion Score) | | | | |
|---|---|---|---|---|---|---|
| | | User | User | User | User | User |
| Config #/ | | Loc. 1 | Loc. 2 | Loc. 3 | Loc. 4 | Loc. 5 |
| Recording # | System# | (Left) | (Btw L&M) | (Middle) | (Btw M&R) | (Right) |
| Config 1/ | S1 (Left) | 3.65 | 3.71 | 3.30 | 3.31 | 3.32 |
| Recording 1 | S2 (Middle) | 3.38 | 3.44 | 3.54 | 3.43 | 3.40 |
| | S3 (Right) | 2.42 | 2.36 | 2.53 | 2.69 | 3.44 |
| Config 2/ | S1 (Middle) | 3.31 | 3.44 | 3.68 | 3.34 | 3.38 |
| Recording 2 | S2 (Left) | 3.32 | 3.21 | 3.21 | 3.16 | 3.06 |
| | S3 (Right) | 2.49 | 2.59 | 2.59 | 3.14 | 3.40 |
| Config 3/ | S1 (Right) | 3.52 | 3.55 | 3.39 | 3.55 | 3.75 |
| Recording 3 | S2 (Left) | 3.37 | 3.31 | 3.02 | 3.03 | 3.10 |
| | S3 (Middle) | 2.38 | 2.79 | 3.11 | 3.24 | 2.65 |

While implementation of the example processes 300 and 600 as well as settings and systems 100, 200, 400, 500, 700, 800, 900, and 1000 discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions of the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality. Other than the term “logic unit”, the term “unit” refers to any one or combination of software logic, firmware logic, hardware logic, and/or circuitry configured to provide the functionality described herein.

As used in any implementation described herein, the term “component” may refer to a module, unit, or logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, and processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

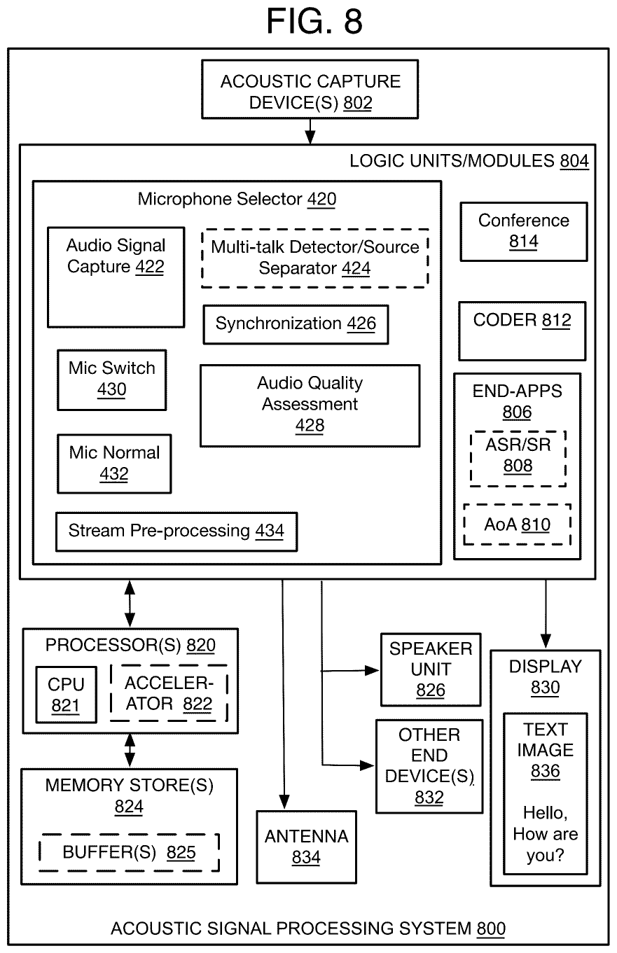

Referring to FIG. 8, an example acoustic signal processing system 800 is arranged in accordance with at least some implementations of the present disclosure. In various implementations, the example acoustic signal processing system 800 may have acoustic capture devices 802, such as listening devices described herein, and has one or more microphones to receive acoustic waves and form acoustical signal data. This can be implemented in various ways. Thus, in one form, the acoustic signal processing system 800 is one of the listening devices, or is on a device, with one or more microphones. In other examples, the acoustic signal processing system 800 may be in communication with one or an array or network of listening devices 802 with microphones, or in communication with at least two microphones. The system 800 may be remote from these acoustic signal capture devices 802 such that logic modules 804 may communicate remotely with, or otherwise may be communicatively coupled to, the microphones for further processing of the acoustic data.

In either case, such technology may include a smart phone, smart speaker, a tablet, laptop or other computer, video or phone conference console, dictation machine, other sound recording machine, a mobile device or an on-board device, or any combination of these. Thus, in one form, audio capture devices 802 may include audio capture hardware including one or more sensors as well as actuator controls. These controls may be part of a sensor module or component for operating the sensor. The sensor component may be part of the audio capture device 802, or may be part of the logical modules 804 or both. Such sensor component can be used to convert sound waves into an electrical acoustic signal. The audio capture device 802 also may have an A/D converter, AEC unit, other filters, and so forth to provide a digital signal for acoustic signal processing.

In the illustrated example, the logic units and modules 804 may include a microphone selector unit 420 and an end-apps unit 806. The microphone selector unit 420 may have those components already described above with FIG. 4, such as an audio signal capture unit 422, an optional multi-talk detector/source separator unit 424, a synchronization unit 426, an audio quality assessment unit 428, a microphone switch unit 430, microphone normalization unit 432, and a stream pre-processing unit 434.

For transmission and emission of the audio, the system 800 may have a coder unit 812 for encoding and an antenna 834 for transmission to a remote output device, as well as a speaker 826 for local emission. When the logic modules 804 are on a host device, the logic modules 804 also may include a conference unit 814 to host and operate a video or phone conference system as mentioned herein.

The logic modules 804 also may include an end-apps unit 806 to perform further audio processing such as with an ASR/SR unit 808, an AoA unit 810, a beam-forming unit, and/or other end applications that may be provided to analyze and otherwise use the audio signals with best or better (or highest or higher) audio quality scores. The logic modules 804 also may include other end devices 832, which may include a decoder to decode input signals when audio is received via transmission, and if not already provided with coder unit 812. These units may be used to perform the operations described above where relevant. The tasks performed by these units or components are indicated by their labels and may perform similar tasks as those units with similar labels as described above.

The acoustic signal processing system 800 may have processor circuitry 820 forming one or more processors which may include central processing unit (CPU) 821 and/or one or more dedicated accelerators 822 such as the Intel Atom, memory stores 824 with one or more buffers 825 to hold audio-related data such as samples, feature vectors, the AQ index, audio quality scores, and so forth as described above, at least one speaker unit 826 to emit audio based on the input audio signals, or responses thereto, when desired, one or more displays 830 to provide images 836 of text for example, as a visual response to the acoustic signals. The other end device(s) 832 also may perform actions in response to the acoustic signal. In one example implementation, the acoustic signal processing system 800 may have the at least one processor of the processor circuitry 820 communicatively coupled to the acoustic capture device(s) 802 (such as at least two microphones of one or more listening devices) and at least one memory 824. As illustrated, any of these components may be capable of communication with one another and/or communication with portions of logic modules 804 and/or audio capture device 802. Thus, processors of processor circuitry 820 may be communicatively coupled to the audio capture device 802, the logic modules 804, and the memory 824 for operating those components.

While typically the label of the units or blocks on device 800 at least indicates which functions are performed by that unit, a unit may perform additional functions or a mix of functions that are not all suggested by the unit label. Also, although acoustic signal processing system 800, as shown in FIG. 8, may include one particular set of units or actions associated with particular components or modules, these units or actions may be associated with different components or modules than the particular component or module illustrated here,

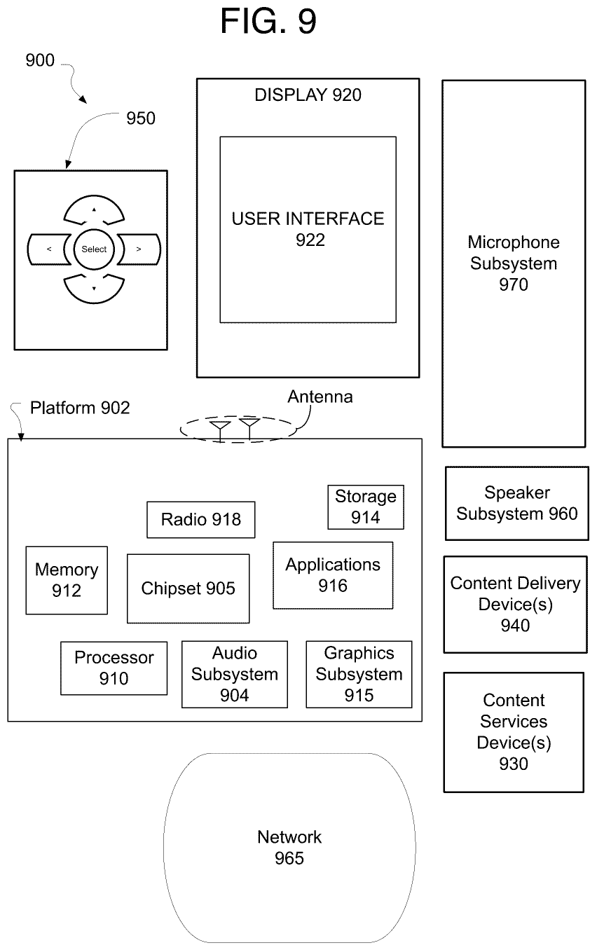

Referring to FIG. 9, an example system 900 in accordance with the present disclosure operates one or more aspects of the speech processing system described herein. It will be understood from the nature of the system components described below that such components may be associated with, or used to operate, certain part or parts of the speech processing system described above. In various implementations, system 900 may be a media system although system 900 is not limited to this context. For example, system 900 may be incorporated into multiple microphones of a network of microphones on listening devices, personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth, but otherwise any device having a network of acoustic signal producing devices.

In various implementations, system 900 includes a platform 902 coupled to a display 920. Platform 902 may receive content from a content device such as content services device(s) 930 or content delivery device(s) 940 or other similar content sources. A navigation controller 950 including one or more navigation features may be used to interact with, for example, platform 902, speaker subsystem 960, microphone subsystem 970, and/or display 920. Each of these components is described in greater detail below.

In various implementations, platform 902 may include any combination of a chipset 905, processor 910, memory 912, storage 914, audio subsystem 904, graphics subsystem 915, applications 916 and/or radio 918. Chipset 905 may provide intercommunication among processor 910, memory 912, storage 914, audio subsystem 904, graphics subsystem 915, applications 916 and/or radio 918. For example, chipset 905 may include a storage adapter (not depicted) capable of providing intercommunication with storage 914. Either audio subsystem 904 or the microphone subsystem 970 may have the microphone selection unit described herein. Otherwise, the system 900 may be or have one of the listening devices.

Processor 910 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 910 may be dual-core processor(s), dual-core mobile processor(s), and so forth.

Memory 912 may be implemented as a volatile memory device such as, but not limited to, a Random Access Memory (RAM), Dynamic Random Access Memory (DRAM), or Static RAM (SRAM).

Storage 914 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 914 may include technology to increase the storage performance enhanced protection for valuable digital media when multiple hard drives are included, for example.

Audio subsystem 904 may perform processing of audio such as acoustic signals for one or more audio-based applications such as audio signal enhancement, microphone switching as described herein, speech recognition, speaker recognition, and so forth. The audio subsystem 904 may have audio conference (or the audio part of video conference) hosting modules. The audio subsystem 904 may comprise one or more processing units, memories, and accelerators. Such an audio subsystem may be integrated into processor 910 or chipset 905. In some implementations, the audio subsystem 904 may be a stand-alone card communicatively coupled to chipset 905. An interface may be used to communicatively couple the audio subsystem 904 to a speaker subsystem 960, microphone subsystem 970, and/or display 920.

Graphics subsystem 915 may perform processing of images such as still or video for display. Graphics subsystem 915 may be a graphics processing unit (GPU) or a visual processing unit (VPU), for example. An analog or digital interface may be used to communicatively couple graphics subsystem 915 and display 920. For example, the interface may be any of a High-Definition Multimedia Interface, Display Port, wireless HDMI, and/or wireless HD compliant techniques. Graphics subsystem 915 may be integrated into processor 910 or chipset 905. In some implementations, graphics subsystem 915 may be a stand-alone card communicatively coupled to chipset 905.

The audio processing techniques described herein may be implemented in various hardware architectures. For example, audio functionality may be integrated within a chipset. Alternatively, a discrete audio processor may be used. As still another implementation, the audio functions may be provided by a general purpose processor, including a multi-core processor. In further embodiments, the functions may be implemented in a consumer electronics device.

Radio 918 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 918 may operate in accordance with one or more applicable standards in any version.

In various implementations, display 920 may include any television type monitor or display. Display 920 may include, for example, a computer display screen, touch screen display, video monitor, television-like device, and/or a television. Display 920 may be digital and/or analog. In various implementations, display 920 may be a holographic display. Also, display 920 may be a transparent surface that may receive a visual projection. Such projections may convey various forms of information, images, and/or objects. For example, such projections may be a visual overlay for a mobile augmented reality (MAR) application. Under the control of one or more software applications 916, platform 902 may display user interface 922 on display 920.

In various implementations, content services device(s) 930 may be hosted by any national, international and/or independent service and thus accessible to platform 902 via the Internet, for example. Content services device(s) 930 may be coupled to platform 902 and/or to display 920, speaker subsystem 960, and microphone subsystem 970. Platform 902 and/or content services device(s) 930 may be coupled to a network 965 to communicate (e.g., send and/or receive) media information to and from network 965. Content delivery device(s) 940 also may be coupled to platform 902, speaker subsystem 960, microphone subsystem 970, and/or to display 920.

In various implementations, content services device(s) 930 may include a network of microphones, a cable television box, personal computer, network, telephone, Internet enabled devices or appliance capable of delivering digital information and/or content, and any other similar device capable of unidirectionally or bidirectionally communicating content between content providers and platform 902 and speaker subsystem 960, microphone subsystem 970, and/or display 920, via network 965 or directly. It will be appreciated that the content may be communicated unidirectionally and/or bidirectionally to and from any one of the components in system 900 and a content provider via network 965. Examples of content may include any media information including. for example, video, music, medical and gaming information, and so forth.

Content services device(s) 930 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 902 may receive control signals from navigation controller 950 having one or more navigation features. The navigation features of controller 950 may be used to interact with user interface 922, for example. In embodiments, navigation controller 950 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures. The audio subsystem 904 also may be used to control the motion of articles or selection of commands on the interface 922.

Movements of the navigation features of controller 950 may be replicated on a display (e.g., display 920) by movements of a pointer, cursor, focus ring, or other visual indicators displayed on the display or by audio commands. For example, under the control of software applications 916, the navigation features located on navigation controller 950 may be mapped to virtual navigation features displayed on user interface 922, for example. In embodiments, controller 950 may not be a separate component but may be integrated into platform 902, speaker subsystem 960, microphone subsystem 970, and/or display 920. The present disclosure, however, is not limited to the elements or in the context shown or described herein.

In various implementations, drivers (not shown) may include technology to enable users to instantly turn on and off platform 902 like a television with the touch of a button after initial boot-up, when enabled, for example, or by auditory command. Program logic may allow platform 902 to stream content to media adaptors or other content services device(s) 930 or content delivery device(s) 940 even when the platform is turned “off.” In addition, chipset 905 may include hardware and/or software support for 8.1 surround sound audio and/or high definition (7.1) surround sound audio, for example. Drivers may include an auditory or graphics driver for integrated auditory or graphics platforms. In embodiments, the auditory or graphics driver may comprise a peripheral component interconnect (PCI) Express graphics card.

In various implementations, any one or more of the components shown in system 900 may be integrated. For example, platform 902 and content services device(s) 930 may be integrated, or platform 902 and content delivery device(s) 940 may be integrated, or platform 902, content services device(s) 930, and content delivery device(s) 940 may be integrated, for example. In various embodiments, platform 902, audio subsystem 904, speaker subsystem 960, and/or microphone subsystem 970 may be an integrated unit. Display 920, speaker subsystem 960, and/or microphone subsystem 970 and content service device(s) 930 may be integrated, or display 920, speaker subsystem 960, and/or microphone subsystem 970 and content delivery device(s) 940 may be integrated, for example. These examples are not meant to limit the present disclosure.

In various implementations, system 900 may be implemented as a wireless system, a wired system, or a combination of both. When implemented as a wireless system, system 900 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 900 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 902 may establish one or more logical or physical channels to communicate information. The information may include media information and control information. Media information may refer to any data representing content meant for a user. Examples of content may include, for example, data from a voice conversation, videoconference, streaming video and audio, electronic mail (“email”) message, voice mail message, alphanumeric symbols, graphics, image, video, audio, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 9.

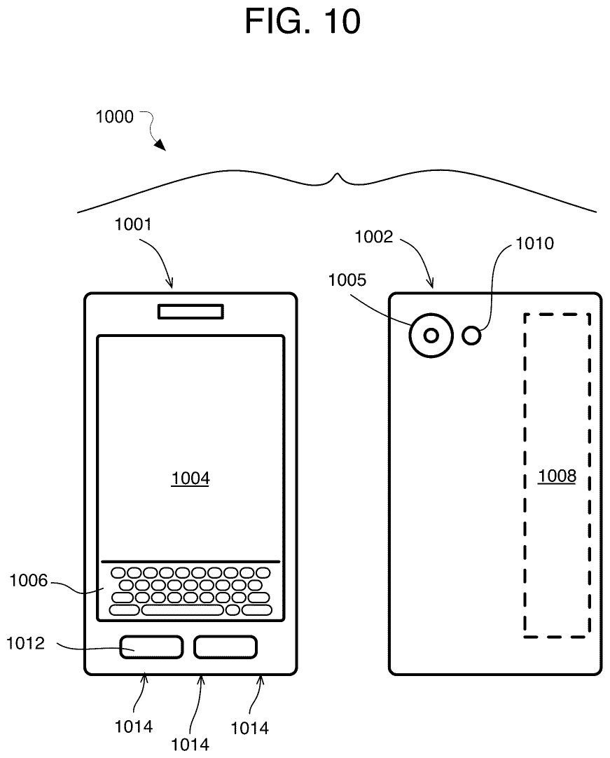

Referring to FIG. 10, a small form factor device 1000 is one example of the varying physical styles or form factors in which systems 800 or 900 may be embodied. By this approach, device 1000 may be implemented as a mobile computing device having wireless capabilities. A mobile computing device may refer to any device having a processing system and a mobile power source or supply, such as one or more batteries, for example.

As described above, examples of a mobile computing device may include any device with an audio sub-system such as a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet, smart speaker, or smart television), mobile internet device (MID), messaging device, data communication device, speaker system, microphone system or network, and so forth, and any other on-board (such as on a vehicle), or building, computer that may accept audio commands.

Examples of a mobile computing device also may include computers that are arranged to be worn by a person, such as a wrist computers, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 10, device 1000 may include a housing with a front 1001 and a back 1002. Device 1000 includes a display 1004, an input/output (I/O) device 1006, and an integrated antenna 1008. Device 1000 also may include navigation features 1012. I/O device 1006 may include any suitable I/O device for entering information into a mobile computing device. Examples for I/O device 1006 may include an alphanumeric keyboard, a numeric keypad, a touch pad, input keys, buttons, switches, microphones, speakers, voice recognition device and software, and so forth. Information also may be entered into device 1000 by way of one or more microphones 1014 that maybe part of a microphone array. As shown, device 1000 may include a camera 1005 (e.g., including a lens, an aperture, and an imaging sensor) and a flash 1010 integrated into back 1002, front 1001, or elsewhere of device 1000.

Various implementations may be implemented using hardware elements, software elements, or a combination of both. Examples of hardware elements may include processor circuitry forming processors and/or microprocessors, as well as circuits, circuit elements (e.g., transistors, resistors, capacitors, inductors, and so forth), integrated circuits, application specific integrated circuits (ASIC), programmable logic devices (PLD), digital signal processors (DSP), fixed function hardware, field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

In example 1, a computer-implemented method of audio processing comprises a computer-implemented method of audio processing, comprising: receiving, by at least one processor, multiple audio signals from multiple microphones, wherein the audio signals are associated with audio emitted from a same source; determining an audio quality indicator of individual ones of the audio signals using a neural network; and selecting at least one of the audio signals depending on the audio quality indicators.

In example 2, the subject matter of example 1, wherein the neural network is trained by at least using a training dataset generated by having one or more people listen to audio samples and rate the audio samples, wherein the audio samples include a single word.

In example 3, the subject matter of example 1 or 2, wherein the neural network is a mean opinion score (MOS) type of neural network.

In example 4, the subject matter of any one of examples 1 to 3, wherein the neural network is a deep noise suppression mean opinion score (DNSMOS) type of neural network.

In example 5, the subject matter of any one of examples 1 to 4, wherein the selecting comprises selecting the microphone with the audio signal with the highest audio quality indicator to be a selected microphone.

In example 6, the subject matter of any one of examples 1 to 5, wherein the selecting comprises determining whether or not a difference in audio quality indicator between an audio signal of a current microphone in use and an initially selected audio signal is greater than a minimum audio signal indicator difference threshold.

In example 7, the subject matter of example 6, comprising setting the threshold at a value to control a frequency of how often one of the audio signals other than a current audio signal being used that is found to have a highest audio quality is to be used.

In example 8, the subject matter of any one of examples 1 to 7, comprising placing an identity of a microphone or audio signal and audio quality indicator in an index after the selecting selects a sample of a sampling time and of a selected audio signal as having a highest audio quality to be used, and using an index sampling count so that either: (a) every nth sample is placed into the index for microphone switching, or (b) every nth sample within the index is used for microphone switching, wherein n is greater than 1.

In example 9, the subject matter of any one of examples 1 to 8, comprising determining at least one first microphone of the multiple microphones has an audio signal with a higher audio quality relative to at least one audio signal of at least one second microphone of the multiple microphones, wherein the at least one second microphone is closer to the source than the at least one first microphone.

In example 10, at least one non-transitory computer readable medium comprising a plurality of instructions that in response to being executed on a computing device, causes the computing device to operate by: receiving, by at least one processor, multiple audio signals from multiple microphones, wherein the audio signals are associated with audio emitted from a same at least one source; determining an audio quality indicator of individual ones of the audio signals using a neural network; and selecting at least one of the audio signals depending on the audio quality indicators.

In example 11, the subject matter of example 10, wherein the selecting comprises selecting an audio signal of a microphone of the multiple microphones that is closest to the source, wherein the selecting is free of distinct computations to determine a location of the source relative to listening devices.

In example 12, the subject matter of example 10 or 11, wherein the instructions cause the computing device to synchronize multiple audio signals from the multiple microphones before providing the audio signals to the neural network.

In example 13, the subject matter of example 12, wherein the audio signals are synchronized within at least about 150 ms of each other.

In example 14, the subject matter of any one of examples 10 to 13, wherein the instructions cause the computing device to normalize values of a current audio signal being used relative to a selected audio signal.

In example 15, the subject matter of any one of examples 10 to 14, wherein the instructions cause the computing device to switch from a current microphone to a selected microphone comprising using a fade-in and fade-out switching.

In example 16, a computer-implemented system, comprises multiple microphones to provide audio signals associated with audio emitted from a same one or more sources; memory to hold data of the audio signals; processor circuitry communicatively connected to the memory and the multiple microphones, the processor circuitry being arranged to operate by: determining an audio quality indicator of individual ones of the audio signals using a neural network; and selecting at least one of the audio signals depending on the audio quality indicators.

In example 17, the subject matter of example 16, comprising sampling the audio signals at intervals set to start every 1 to 10 seconds, or start every 2 seconds to generate the audio quality indicators at individual sample times.

In example 18, the subject matter of example 16 or 17, wherein the processor circuitry is arranged to deactivate the determining and selecting when multiple sources are talking at the same time.

In example 19, the subject matter of example 16 or 17, wherein the processing circuitry is arranged to perform source separation comprising generating separate audio signals of each a different source of multiple sources associated with a single microphone, performing the determining on each separate audio signal so that each separate audio signal receives a separate audio quality indicator, and combining the separate audio quality indicators to generate a single indicator for a microphone with the multiple sources.

In example 20, the subject matter of any one of examples 16 to 19, wherein the neural network comprises an input layer to receive audio signal values without conversion to a Mel-frequency related domain, one or more convolutional layers, and an output layer with one node that outputs an audio quality score as the audio quality indicator for a single audio signal sample.

In example 21, a device or system includes a memory and processor circuitry to perform a method according to any one of the above examples.

In example 22, at least one machine readable medium includes a plurality of instructions that in response to being executed on a computing device, cause the computing device to perform a method according to any one of the above examples.

In example 23, an apparatus may include means for performing a method according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to any example methods herein may be implemented with respect to any example apparatus. example systems, and/or example articles, and vice versa.

What is claimed is:

1. A computer-implemented method of audio processing, comprising:
receiving, by at least one processor, multiple audio signals from multiple microphones, wherein the audio signals are associated with audio emitted from a same source;
determining an audio quality indicator of individual ones of the audio signals using a neural network; and
selecting at least one of the audio signals depending on the audio quality indicators.

2. The method of claim 1, wherein the neural network is trained by at least using a training dataset generated by having one or more people listen to audio samples and rate the audio samples, wherein the audio samples include a single word.

3. The method of claim 1, wherein the neural network is a mean opinion score (MOS) type of neural network.

4. The method of claim 1, wherein the neural network is a deep noise suppression mean opinion score (DNSMOS) type of neural network.

5. The method of claim 1, wherein the selecting comprises selecting the microphone with the audio signal with the highest audio quality indicator to be a selected microphone.

6. The method of claim 5, wherein the selecting comprises determining whether or not a difference in audio quality indicator between an audio signal of a current microphone in use and an initially selected audio signal is greater than a minimum audio signal indicator difference threshold.

7. The method of claim 6, comprising setting the threshold at a value to control a frequency of how often one of the audio signals other than a current audio signal being used that is found to have a highest audio quality indicator is to be used.

8. The method of claim 1, comprising placing an identity of a microphone or audio signal and audio quality indicator in an index after the selecting selects a sample of a sampling time and of a selected audio signal as having a highest audio quality to be used, and using an index sampling count so that either:
(a) every nth sample is placed into the index for microphone switching, or
(b) every nth sample within the index is used for microphone switching,
wherein n is greater than 1.

9. The method of claim 1, comprising determining at least one first microphone of the multiple microphones has an audio signal with at least a higher audio quality relative to at least one audio signal of at least one second microphone of the multiple microphones, wherein the at least one second microphone is closer to the source than the at least one first microphone.

10. At least one non-transitory computer readable medium comprising a plurality of instructions that in response to being executed on a computing device, causes the computing device to operate by:
receiving, by at least one processor, multiple audio signals from multiple microphones, wherein the audio signals are associated with audio emitted from a same at least one source;
determining an audio quality indicator of individual ones of the audio signals using a neural network; and
selecting at least one of the audio signals depending on the audio quality indicators.

11. The medium of claim 10, wherein the selecting comprises selecting an audio signal of a microphone of the multiple microphones that is closest to the source, wherein the neural network factors proximity of the multiple microphones to the source.

12. The medium of claim 10, wherein the instructions cause the computing device to synchronize multiple audio signals from the multiple microphones before providing the audio signals to the neural network.

13. The medium of claim 12, wherein the audio signals are synchronized within at least about 150 ms of each other.

14. The medium of claim 10, wherein the instructions cause the computing device to normalize values of a current audio signal being used relative to a selected audio signal.

15. The medium of claim 10, wherein the instructions cause the computing device to switch from a current microphone to a selected microphone comprising using a fade-in and fade-out switching.

16. A computer-implemented system, comprising:
multiple microphones to provide audio signals associated with audio emitted from a same one or more sources;
memory to hold data of the audio signals;
processor circuitry communicatively connected to the memory, the processor circuitry being arranged to operate by:
determining an audio quality indicator of individual ones of the audio signals using a neural network; and
selecting at least one of the audio signals depending on the audio quality indicators.

17. The system of claim 16, comprising sampling the audio signals at intervals set to start every 1 to 10 seconds, or start every 2 seconds to generate the audio quality indicators at individual sample times.

18. The system of claim 16, wherein the processing circuitry is arranged to deactivate the determining and selecting when multiple sources are talking at the same time.

19. The system of claim 16, wherein the processing circuitry is arranged to perform source separation comprising generating separate audio signals of each a different source of multiple sources associated with a single microphone, performing the determining on each separate audio signal so that each separate audio signal receives a separate audio quality indicator, and combining the separate audio quality indicators to generate a single indicator for a microphone with the multiple sources.

20. The system of claim 16, wherein the neural network comprises an input layer to receive audio signal values without conversion to a Mel-frequency related domain, one or more convolutional layers, and an output layer with one node that outputs an audio quality score as the audio quality indicator for a single audio signal sample.
